(19) United States
(12) Patent Application Publication
(10) Pub. No.: US 2024/0238705 A1
(43) Pub. Date: Jul. 18, 2024

(54) ROTARY DISK FILTER FOR FILTERING WASTE WATER, AND SPRAY NOZZLE FOR A ROTARY DISK FILTER

(71) Applicant: HUBER SE, Berching (DE)

(72) Inventor: Simon Flierl, Beilngries (DE)

(21) Appl. No.: 18/413,402

(22) Filed: Jan. 16, 2024

(30) Foreign Application Priority Data
Jan. 17, 2023 (DE) 10 2023 101 027.1

(51) Int. Cl. B01D 33/21; B01D 33/073

(52) U.S. Cl. CPC B01D 33/21; B01D 33/073

(57) ABSTRACT

A rotary disk filter includes a drum and filter disks. Each filter disk has an inner hollow space, at least a portion of which is delimited by filter surfaces, wherein the hollow spaces are fluidically connected to the drum such that the waste water can flow from the interior of the drum into the hollow spaces and, from there, the filtrate can flow across the filter surfaces toward the outside. The rotary disk filter also has a spray nozzle arrangement including spray nozzle tubes and spray nozzles mounted on the spray nozzle tubes. In one aspect, the spray nozzles each have two spray nozzle sections (each having at least one nozzle head), and an interlocking connection, by means of which the spray nozzle sections are connected to the spray nozzle tubes. The spray nozzles can be removed from the spray nozzle tube once the interlocking connection has been released.

### CROSS-REFERENCE TO RELATED APPLICATIONS

The present application is based upon and claims the right of priority to German Patent Application No. 10 2023 101 027.1, filed Jan. 17, 2023, the disclosure of which is hereby incorporated by reference herein in its entirety for all purposes.

### FIELD OF THE INVENTION

The present subject matter relates to a rotary disk filter for filtering waste water, with the rotary disk filter having a drum which is mounted so as to be rotatable about a rotational axis. The rotary disk filter also has a plurality of filter disks, which are arranged next to one another and around the drum, and which are mounted on the drum and can be set into a rotary motion together with the drum by means of a drive device of the rotary disk filter. Each filter disk has an inner hollow space, at least a portion of which is delimited by filter surfaces. The hollow spaces of the filter disks are fluidically connected to the drum such that the waste water to be filtered can flow from the interior of the drum into the hollow spaces and, from there, the filtrate can flow across the filter surfaces toward the outside. The rotary disk filter also has a spray nozzle arrangement for cleaning an outer side of the filter surfaces facing away from the hollow space. The spray nozzle arrangement includes spray nozzle tubes which at least intermittently extend between each pair of adjacent filter disks during the operation of the spray nozzle arrangement. The spray nozzle tubes each have multiple spray nozzles, by means of which a cleaning liquid fed to the spray nozzle tubes during the operation of the spray nozzle arrangement can be sprayed onto the outer side of a filter surface facing the spray nozzle.

The present subject matter also relates to a spray nozzle for a rotary disk filter.

### BACKGROUND OF THE INVENTION

A rotary disk filter of the type in question is known, for example, from DE 10 2020 117 493 A1 or from DE 10 2014 103 831 A1. Corresponding rotary disk filters—and this also applies for the rotary disk filter according to the present invention—are utilized, for example, for removing solids from waste water.

In principle, the rotary disk filter includes a receptacle in which the individual filter disks are arranged adjacent to one another on the drum. The drum is drivable about its longitudinal axis (i.e., a rotational axis) by means of a drive (preferably in the form of an electric motor) and together with the individual filter disks. If the waste water to be treated is now conducted into the drum, it subsequently flows from the inside toward the outside through the filter surfaces of the individual filter disks. Solids present in the waste water are retained by the filter surfaces of the filter disks, the efficiency of the removal of the solids depending on the properties of the filter surfaces. Preferably, the filter surfaces consist of a filtration non-woven, a woven fabric (made of plastic or metal) or a pile cloth (this also applies for the present rotary disk filter). The filtrate emerging on the outer sides of the filter disks is then discharged from the rotary disk filter.

As described in DE 10 2014 103 831 A1, spray nozzle arrangements can be used, by means of which the outer sides of the filter surfaces facing away from the hollow spaces can be sprayed with a cleaning liquid in order to clean the filter material by backwashing. The liquid is therefore sprayed onto the filter surfaces from the outside and penetrates the filter surfaces in the direction of the hollow spaces, while the filtrate passes from the hollow spaces through the filter surfaces toward the outside over the course of filtration. The spray nozzle arrangements can include one or more spray nozzle(s), which are directed toward one or more filter disk(s) and by means of which the cleaning liquid, for example, in the form of the filtrate or water supplied from the outside, can be sprayed onto the filter disks.

It is known that multiple spray nozzle sections are connected to a spray nozzle tube, via which the cleaning liquid is fed to the spray nozzle sections. The spray nozzle sections are non-detachably mounted on the spray nozzle tube and cannot be removed therefrom without damage. Maintenance is therefore generally quite complex.

### SUMMARY OF THE INVENTION

In various aspects, the present subject matter addresses one or more problems in the prior art by providing a low-maintenance spray nozzle and a rotary disk filter equipped therewith.

In various aspects, the problem(s) is solved by a rotary disk filter and by a spray nozzle having the features described and claimed herein.

In one aspect, the rotary disk filter has a plurality of spray nozzle tubes, via which a cleaning liquid can be fed to the individual spray nozzles in order to clean the outer sides of the filter disks by backwashing, i.e., from outside to inside. The cleaning liquid (for example, water or filtrate arising during the operation of the rotary disk filter) flows during operation of the spray nozzle arrangement from the spray nozzle tube through the spray nozzle sections of the spray nozzles connected to the spray nozzle tube, with the spray nozzles having a nozzle head. From there, the cleaning liquid flows to the nozzle heads and, after emerging from the nozzle heads, impacts an outer side of one of the filter surfaces.

In one embodiment, the rotary disk filter has multiple spray nozzle tubes, with one spray nozzle tube projecting between each pair of adjacent filter disks. The spray nozzle tubes can be mounted such that they can be moved, preferably pivoted, from a cleaning position between two adjacent filter disks into a park position, in which they do not project between adjacent filter disks. In one embodiment, a spray nozzle tube can also be arranged on the outer side of the first and the last filter disks of the rotary disk filter facing away from the rest of the filter disks. In such an embodiment, the spray nozzle tube has spray nozzles which deviate structurally from the spray nozzles arranged between the filter disks, since only one filter surface needs to be sprayed here. The following description therefore relates only to the spray nozzles which are arranged on spray nozzle tubes which can be moved between two adjacent filter disks or are constantly arranged here.

In one embodiment, multiple spray nozzle tubes are present, the spray nozzle tubes being connected to one or more central supply line(s) for supplying the cleaning liquid. The central supply line(s) can extend, for example, parallel to the rotational axis of the drum. Furthermore, the central supply line(s) should be connected to a pump assembly, for example, to a liquid pump, by means of which the cleaning liquid can be pumped through the central supply line(s) to the individual spray nozzle tubes.

In one aspect, the rotary disk filter is initially characterized in that the spray nozzles each include at least (preferably precisely) two spray nozzle sections, at least one part of the spray nozzle sections having a nozzle head. Additionally, the spray nozzles have an interlocking connection, by means of which the spray nozzle sections are connected to the spray nozzle tubes.

In one embodiment, the spray nozzle sections of a spray nozzle are separate components which can be identically or differently designed. Preferably, the spray nozzle sections are identical and designed as a spray nozzle arm, with each spray nozzle arm having one nozzle head.

It is also conceivable that only one of the multiple spray nozzle sections of a spray nozzle has a nozzle head. It is possible, for example, that the spray nozzle has two spray nozzle sections, only one of which is designed as a spray nozzle arm having a nozzle head. The second spray nozzle section has only one or more of the sections of the interlocking connection described in greater detail in the following and, therefore, is not used as the outlet of cleaning liquid, but rather only for connecting the spray nozzle to the spray nozzle tube and for stabilizing the spray nozzle.

For example, spray nozzles designed in such a way could be arranged on the spray nozzle tubes which are assigned to the outer sides of the two particular outermost filter disks of the rotary disk filter, since only one filter disk needs to be sprayed with cleaning liquid here.

The spray nozzle sections designed as spray nozzle arms, viewed from the particular spray nozzle tube, project toward the outside and subsequently open into the nozzle heads. During the operation of the spray nozzle arrangement, the cleaning liquid therefore flows from one particular spray nozzle tube via the spray nozzle arm connected thereto, to the particular nozzle head and, therefore, emerges from the spray nozzle arrangement in the direction of the outer sides of the individual filter disks.

According to the present subject matter, an interlocking connection is now present, by means of which two spray nozzle sections in each case, i.e., the spray nozzle sections of a spray nozzle, are connected to one of the numerous spray nozzle tubes. The interlocked connection is achieved, for example, via the mutual engagement of at least two sections of the two spray nozzle sections of a spray nozzle or by one section of a spray nozzle section and a corresponding section of the spray nozzle tube. The interlocking connection can therefore be established between the spray nozzle sections themselves (see the following description) or also between one spray nozzle section and the spray nozzle tube connected to the spray nozzle section. In any case, connection sections are present, which directly or indirectly bring about an interlocking connection between the two spray nozzle sections of a spray nozzle and one spray nozzle tube in each case.

It is also conceivable that the interlocking connection has separate elements, in addition or alternatively to sections of a spray nozzle tube and/or of one or more spray nozzle sections, the separate elements bringing about the interlocking connection. These include, for example, pins, bolts or rivets. Screws can therefore be dispensed with entirely.

An interlocking connection is particularly preferred, which can be released without a tool, i.e., merely by hand, such that the spray nozzle sections of the individual spray nozzles can be quickly and easily connected to or disconnected from a spray nozzle tube. In particular, the latching or snap-in connections described in the following are used for the interlocking connection.

In any case, the interlocking connection is designed such that the spray nozzles can be removed from the particular spray nozzle tube once the interlocking connection has been released.

It is also advantageous when two spray nozzle sections in each case are combined by means of the interlocking connection to form a unit. For example, it would be conceivable to connect two spray nozzle sections in each case via interlocking connection elements to form the aforementioned unit. It would also be conceivable for the spray nozzle tubes to have connection sections which are simultaneously connected to both spray nozzle sections of a spray nozzle, such that the aforementioned unit arises.

It is advantageous, in particular, when the spray nozzle sections of a spray nozzle are each designed as a spray nozzle arm and each have a nozzle head. The spray nozzle arms preferably project in opposite directions from the spray nozzle tube with respect to the spray nozzle tube supporting the spray nozzle arms.

In general, the spray nozzle sections, or the nozzle heads connected to the spray nozzle sections designed as a spray nozzle arm, are oriented such that one nozzle head of a spray nozzle sprays the outer side of a first filter disk and the second nozzle head of the spray nozzle sprays the outer side of a second filter disk, which is adjacent to the first filter disk. During operation of the spray nozzle arrangement, the spray nozzles are therefore arranged between two filter disks such that the two nozzle heads of a spray nozzle spray, and therefore clean, opposing outer sides of two filter disks. As mentioned at the beginning, this does not apply for the spray nozzles which spray the first and the last filter disks on the outer side in each case, the outer side facing away from the rest of the filter disks.

It is also conceivable that each spray nozzle has only one nozzle head, wherein, in this case, multiple such spray nozzles per spray nozzle tube are arranged such that, during operation of the spray nozzle arrangement, a first portion of the spray nozzles sprays a first filter disk of the two filter disks adjacent to the spray nozzle tube with cleaning liquid, while the second filter disk of the aforementioned filter disks is sprayed by the second portion of the spray nozzles. Preferably, the spray nozzles of the first portion and the spray nozzles of the second portion are mounted in alternation on the spray nozzle tube.

It is also advantageous when the spray nozzle sections of one unit are directly connected to one another, i.e., touch one another, by means of the interlocking connection. The interlocking connection is used in this case not only to connect the spray nozzle sections to the particular spray nozzle tube. Rather, the spray nozzle sections of one unit are also connected to one another by means of the interlocking connection and, therefore, are in direct contact. The interlocking connection can have sections which extend around a spray nozzle tube in the circumferential direction, the sections of the two spray nozzle sections touching and being shaped such that the interlocking connection results.

It is also advantageous when the interlocking connection is formed by a latching mechanism. The latching mechanism includes a latching section, which is an integral part of a first of the two spray nozzle sections of one unit. Furthermore, the latching mechanism includes a retaining section, which is an integral part of the second spray nozzle section of the unit. The latching section and the retaining section interact, i.e., engage into one another, and jointly form the interlocking connection. Both the latching section and the retaining section are an integral part of one spray nozzle section, the latching section being arranged on a first spray nozzle section and the retaining section being arranged on a second spray nozzle section of the spray nozzle. In addition, the latching section and the retaining section interlockingly engage into one another such that the two spray nozzle sections of one spray nozzle are interlockingly connected. The spray nozzle sections of the unit are preferably pressed against the spray nozzle tube supporting the unit by means of the latching mechanism. If the latching section is now manually removed from the retaining section until the two sections become disengaged, the interlocking connection is released and both spray nozzle sections can be removed from the spray nozzle tube.

It is also advantageous when each spray nozzle section has at least one, preferably multiple, latching section(s) and one, preferably multiple, retaining section(s). The latching section(s) of the first spray nozzle section of one unit interact(s) with the retaining section(s) of the second spray nozzle section, and the latching section(s) of the second spray nozzle section of the unit interact(s) with the retaining section(s) of the first spray nozzle section. A unit therefore includes two spray nozzle sections, with each spray nozzle section having at least one retaining section and at least one latching section. The latching section(s) of the first spray nozzle section interact(s) with the retaining section(s) of the second spray nozzle section, and vice versa. Preferably, the latching section(s) are positioned opposite the retaining section(s) of the same spray nozzle section, i.e., the retaining section(s) and the latching section(s) of one spray nozzle section are located on different sides of the spray nozzle tube supporting the spray nozzle sections. In particular, it is advantageous when the aforementioned sections of the spray nozzle sections enclose or clasp the spray nozzle tube supporting the spray nozzle sections in the circumferential direction. The spray nozzle sections can have regions in the shape of a half-shell for this purpose, the regions resting, in particular, directly against the spray nozzle tube. Preferably, one unit completely encloses one spray nozzle tube in the circumferential direction in each case.

In order to prevent a unit from moving in the longitudinal direction of a spray nozzle tube or of the section thereof supporting the unit or to prevent the unit from turning in the circumferential direction of the spray nozzle tube, it is also advantageous when, in particular, the spray nozzle sections which include a nozzle head (alternatively also all spray nozzle sections) have a bulge, for example, in the form of a connector, which projects into a corresponding opening in the spray nozzle tube. The connector can have an inner passage, via which the spray nozzle liquid emerges from the spray nozzle tube into the spray nozzle section. The spray nozzle sections which have a connector, but not a nozzle head, can have a closed connector which is used to seal the spray nozzle section with respect to an opening in the spray nozzle tube, but is not used to transport cleaning liquid.

It is advantageous when at least one spray nozzle section of each spray nozzle has an arm section which projects from the spray nozzle tube to which it is connected, the corresponding spray nozzle section being formed in one piece and the arm section including one or more latching section(s) and/or one or more retaining sections, with the arm section being connected to one of the nozzle heads. It is therefore advantageous when each spray nozzle has only two spray nozzle sections and one or two nozzle heads (depending on whether only one spray nozzle section or both spray nozzle sections of a spray nozzle has/have a nozzle head). The spray nozzle sections can be made of plastic as a one-piece injection-molded part. If necessary, the spray nozzle can also have one or more sealing element(s), for example, sealing ring(s), wherein the sealing elements can be arranged in association with one arm section and one nozzle head in each case and/or between one spray nozzle section and the spray nozzle tube supporting the spray nozzle section, in order to prevent an undesirable leak of the spray liquid.

It is also advantageous when the latching section and/or the retaining section, in particular proceeding from the arm section, extend(s) in the circumferential direction around a section of one of the spray nozzle tubes. As a result, the spray nozzle tube is clasped entirely or at least over a portion of its circumference by the spray nozzles or by the latching section(s) and/or the retaining section(s), which ensures a particularly stable connection between the spray nozzles and the tube sections of the particular spray nozzle tube.

It is also advantageous when the latching section is formed by a latching hook. The latching hook latches into the retaining section when the interlocking connection is established. In particular, the latching hooks and the retaining sections are oriented relative to the particular spray nozzle tube such that, in each case, two spray nozzle sections can be connected to form a unit when the two spray nozzle sections are moved toward one another from different sides in the direction of the spray nozzle tube until the latching section(s) become operatively connected to the corresponding retaining section(s) and, as a result, form the interlocking connection.

It is particularly advantageous when the latching section has one actuating section which preferably projects from the spray nozzle tube and by means of which the latching section can be manually moved apart from the retaining section in order to release the interlocking connection due to the movement of the actuating section. In particular, the actuating section projects outwards such that it can be contacted by a finger and moved away from the spray nozzle tube. The latching section disengages from the retaining section, as a result of which the interlocking connection is released. Once the connection has been released, the spray nozzle sections of the particular spray nozzles can be removed from the spray nozzle tube to which they were previously connected, without the need to release further connections for this purpose.

It is also advantageous when a nozzle head is screwed together with a spray nozzle section, which is preferably formed as a spray nozzle arm, and is connected thereto via a clip mechanism or is pressed together therewith, preferably being pressed therein. In particular, a clip mechanism allows the nozzle head to be easily and quickly connected to the particular spray nozzle section, The connection can also be released easily and without a tool when a nozzle head is to be replaced.

It is advantageous when each spray nozzle has exclusively two spray nozzle sections, each of which is formed as one piece, one or two nozzle head(s) and multiple sealing elements, one sealing element being arranged between the particular spray nozzle section and the spray nozzle tube and one sealing element being arranged between the particular spray nozzle section and the nozzle head connected thereto. As mentioned above, the spray nozzle sections can be produced as an injection-molded part. The design of the spray nozzles is kept relatively simple as a result, such that the manufacturing costs are low in comparison to the prior art. The spray nozzles can also be installed and deinstalled or removed easily and without a tool.

It is also extremely advantageous when the interlocking connection is formed by a toggle clamp, the toggle clamp including, per unit, one, preferably multiple clamping arm(s) and one, preferably multiple projection(s). At least one clamping arm is engaged with at least one projection in each case. Preferably, the spray nozzle sections of the unit are pressed against the spray nozzle tube supporting the unit due to the interaction of the clamping arms with the projections. In any case, the toggle clamp is used to connect the spray nozzle sections to one spray nozzle tube in each case. In particular, it is also advantageous here when two spray nozzle sections are connected to form one unit in each case, wherein the connection can be realized via the interlocking connection. The toggle clamp is designed such that the clamping arm is brought into contact with the projection upon establishing the interlocking connection. Thereafter, the clamping arm is moved a bit further until it has assumed an end position in which it is under a certain amount of tension and, as a result, pulls the first spray nozzle section of a unit against the second spray nozzle section of the same unit. The clamping arm can be subsequently released by moving the clamping arm in a direction that is opposite the direction in which the interlocking connection is established. Thereafter, the spray nozzle sections can be removed from the spray nozzle tube.

It is also advantageous when the toggle clamp has a spring mechanism, by means of which the toggle clamp is held under tension, wherein the toggle clamp can be opened by overcoming the spring force of the spring mechanism. The spring force must be overcome both when establishing and releasing the interlocking connection, the spring force ensuring, once the interlocking connection has been established, that the toggle clamp can be released only by overcoming the spring force. The spring mechanism therefore ensures that the spray nozzle sections are securely mounted on the spray nozzle tube supporting the spray nozzle sections during operation of the spray nozzle arrangement.

It is also advantageous when each clamping arm of a unit has a clamping arm and a projection, the clamping arm of the first spray nozzle section of the unit being operatively connected to a projection of the second unit and the clamping arm of the second spray nozzle section of the unit being operatively connected to a projection of the first unit. In this case, each spray nozzle has at least two interlocking connections, by means of which the two spray nozzle sections are pulled toward one another and, as a result, are also pressed against the corresponding spray nozzle tube. Preferably, the two clamping arms are arranged on opposite sides of the spray nozzle tube. This also applies for the two projections.

It is particularly advantageous, therefore, when the clamping arms of a unit are arranged on opposite sides of the spray nozzle tube supporting the unit and/or when the projections of a unit are arranged on opposite sides of the spray nozzle tube supporting the unit. It is also advantageous when the latching sections of a unit are arranged on opposite sides of the spray nozzle tube supporting the unit and/or when the retaining sections of a unit are arranged on opposite sides of the spray nozzle tube supporting the unit. In these cases, force is introduced relatively uniformly from the spray nozzle sections in the direction of the spray nozzle tube arranged between the spray nozzle sections of a unit. The two spray nozzle sections of a unit clasp the spray nozzle tube in this case.

In addition, the present subject matters relates to a spray nozzle for a rotary disk filter which is used to filter waste water and preferably has one or more of the features of the rotary disk filter described above and/or described in the following (also in the description of the figures). According to the present subject matter, the spray nozzle has one or more of the features of the spray nozzle described above or in the following. The features which relate to the spray nozzle can be realized individually or in any combination, provided no technical inconsistencies arise.

### BRIEF DESCRIPTION OF THE FIGURES

Further advantages of the invention are described in the following exemplary embodiments, wherein, schematically:

FIG. 1 shows selected components of a rotary disk filter,

FIG. 2 shows one exemplary embodiment according to aspects of the present subject matter of a section of a spray nozzle tube supporting the spray nozzles,

FIG. 3 shows a unit according to aspects of the present subject matter, including two spray nozzle sections and two nozzle heads,

FIG. 4 shows an exploded view of the unit shown in FIG. 3,

FIG. 5 shows a unit of one alternative embodiment of a spray nozzle according to aspects of the present subject matter,

FIG. 6 shows the unit according to FIG. 5 in a side view,

FIG. 7 shows a spray nozzle section of the unit shown in FIGS. 5 and 6; and

FIG. 8 shows one alternative embodiment of a spray nozzle according to aspects of the present subject matter.

### DETAILED DESCRIPTION

In the following description of the alternative exemplary embodiments of the present subject matter, the same reference signs are utilized for features that are identical or at least comparable in terms of their configuration and/or mode of operation. Provided the features are not described in detail again, their design and/or mode of operation correspond/corresponds to the design and mode of operation of the above-described features. For the sake of greater clarity, reference signs for previously described components have not been individually included in the figures.

Additionally, it is pointed out that in some of the figures only some of multiple elements of the same kind (such as, for example, the spray nozzle tubes 8) are provided with a reference character, for the sake of greater clarity. In principle, similarly shown elements are elements of the same kind, however, even though not all elements of this type are provided with a reference character.

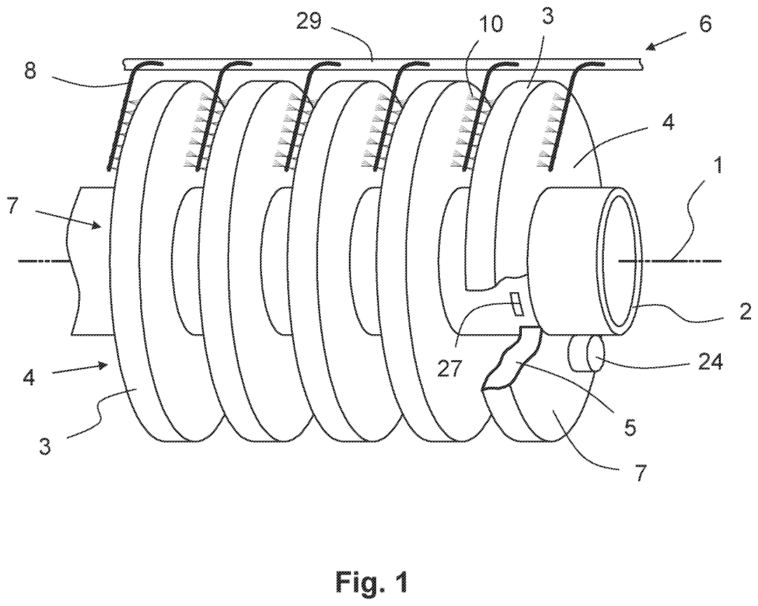

FIG. 1 shows relevant sections and components of a rotary disk filter. The rotary disk filter includes a drum 2, which is rotatably mounted in a frame (not shown) via bearings (not shown). A plurality of filter disks 3 are mounted on the outer periphery of the drum 2 (wherein only two filter disks 3 are provided with a reference character in FIG. 1 for the sake of clarity). The filter disks 3 each have two substantially annular filter surfaces 4, which delimit an interior hollow space 5 (visible on the right filter disk 3, in which a portion of the filter disk 3 has been omitted in order to be able to look inside).

Additionally, the rotary disk filter includes further components, such as, for example, a receptacle (not shown) for the waste water to be treated, the receptacle enclosing the filter disks 3, and/or a drive device 24 (preferably in the form of an electric motor), by means of which the drum 2 and the filter disks 3 mounted thereon are driven in a rotary motion about a rotational axis 1.

Furthermore, the rotary disk filter includes an intake (not shown) for the waste water to be filtered and a discharge (also not shown) for the filtrate.

A discharge device (not shown) is present, by means of which the solids retained by the filter surfaces 4 of the filter disks 3 can be removed from the rotary disk filter.

During the filtration of the waste water to be filtered, the waste water flows via the drum 2 and eventually via the waste water openings 27 in the drum 2 into the inner hollow spaces 5 of the individual filter disks 3 (their base frames, which support the filter material forming the filter surfaces 4, have corresponding openings).

While the filtrate flows through the filter surfaces 4 of the filter disks 3 from the hollow spaces 5 arranged within the filter disks 3 toward the outside of the filter disks 3, solids up to a certain particle size are retained by the filter surfaces 4 of the filter disks 3. In this way, the solids are separated from the filtrate.

In order to now be able to clean the retained solids off the filter surfaces 4, the rotary disk filter according to the present subject matter has a spray nozzle arrangement 6. In the exemplary embodiment shown, the spray nozzle arrangement 6 has a central supply line 29 for a cleaning liquid 10 (for example, water or filtrate), only a portion of the supply line 29 being shown. The supply line 29 is supplied with the cleaning liquid 10 by a pump (not shown), wherein the cleaning liquid 10 can originate, for example, from a reservoir tank (not shown).

Multiple spray nozzle tubes 8 branch off from the central supply line 29, and in turn, act as supports for multiple spray nozzles 9 in each case. The spray nozzle tubes 8 can be fixed in place. It is also conceivable that the spray nozzle tubes 8 are pivotable about a pivot axis which extends, for example, through the portion of the central supply line 29 shown and can be moved between a park position outside the filter disks 3 and the cleaning position shown in FIG. 1. In the cleaning position, the spray nozzles 9, with the exception of the spray nozzles 9 on the first and the last spray nozzle tubes 8, are located between each pair of adjacent filter disks 3.

If the cleaning liquid 10 is now sprayed via the spray nozzles 9 onto the outer sides 7 of the filter disks 3, the cleaning liquid 10 penetrates the filter disks 3 in the direction of the inner hollow spaces 5 and subsequently causes the solids collected on the inner side of the filter disks 3 to detach. The solids, together with a portion of the cleaning liquid 10, are subsequently collected via the drum 2 or a collecting device extending in the interior thereof and discharged toward the outside.

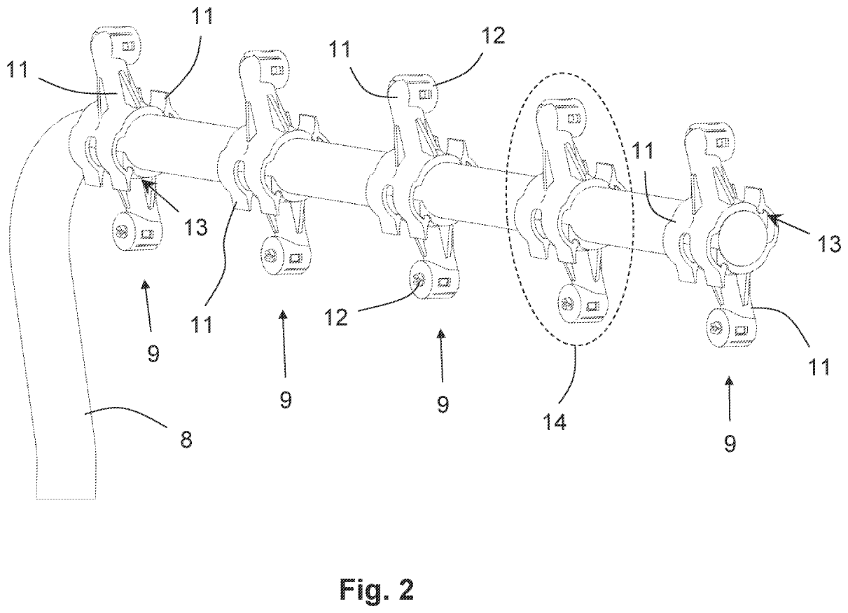

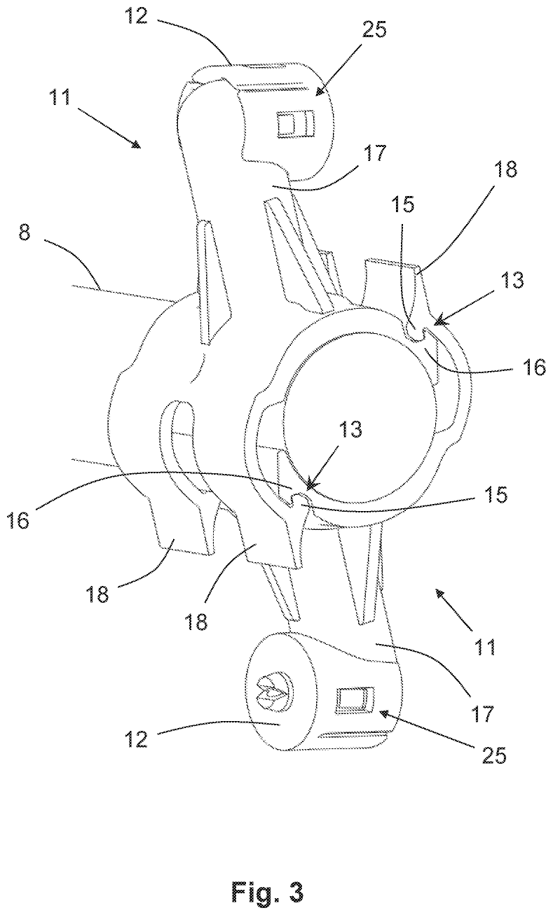

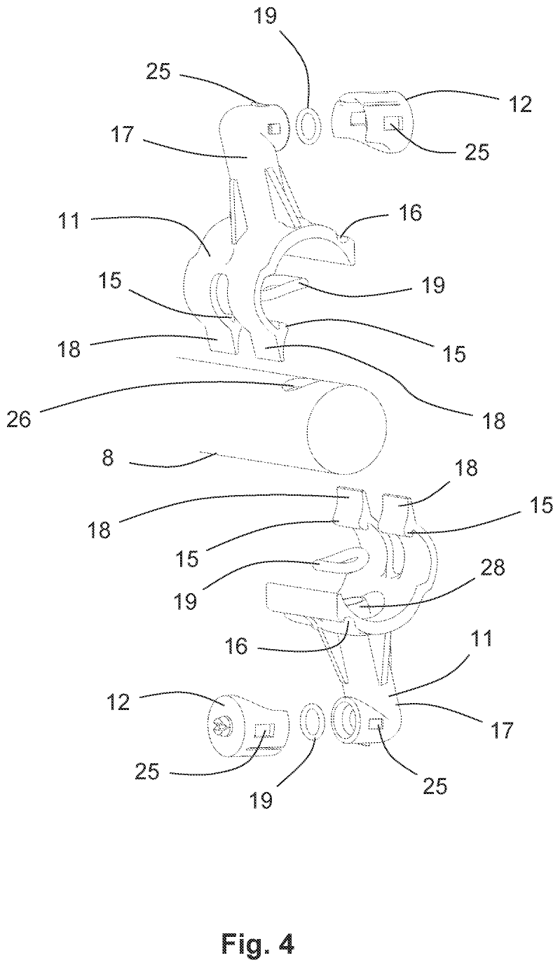

A first exemplary embodiment of the spray nozzles 9 designed according to the invention is shown by FIGS. 2 through 4 in combination, FIG. 2 showing a section of a spray nozzle tube 8 having five spray nozzles 9 mounted thereon. In FIG. 3, a spray nozzle 9 is shown in its mounted state on the spray nozzle tube 8, while FIG. 4 shows an exploded view of the spray nozzle 9 shown in FIG. 3.

As is apparent from the aforementioned figures, each spray nozzle 9 includes two spray nozzle sections 11, which are each designed as a spray nozzle arm and are connected to one another and simultaneously also to the spray nozzle tube 8 by means of an interlocking connection 13 and, as a result, form a unit 14. Furthermore, each spray nozzle section 11 has an outwardly projecting arm section 17 which is connected at its end facing away from the spray nozzle tube 8 to a nozzle head 12, via which the cleaning liquid 10 supplied via the spray nozzle tube 8 subsequently emerges from the spray nozzle 9 and impacts the filter surface 4. The nozzle head 12 and the spray nozzle tube 8 are preferably connected by means of the clip mechanism 25, which is shown, for example, in FIG. 4, such that the nozzle head 12 can be easily removed from the spray nozzle section 11 as necessary and replaced by a new nozzle head.

During operation of the spray nozzle arrangement 6, the cleaning liquid 10 flows from the spray nozzle tube 8 via an opening 26 in the spray nozzle tube 8 into the arm section 17 of the particular spray nozzle section 11 and, from there, into the nozzle head 12. Preferably, the spray nozzle section 11 has a tubular connector 28 which projects into the corresponding opening 26 in the spray nozzle tube 8 when the spray nozzle 9 is installed. The interaction of the connector 28 and the opening 26 simultaneously acts as a rotation lock of the spray nozzle 9 with respect to the spray nozzle tube 8.

In order to prevent an undesirable leak of the cleaning liquid 10, sealing elements 19, for example in the form of sealing rings, are arranged between the spray nozzle sections 11 and the spray nozzle tube 8 and between the nozzle heads 12 and the spray nozzle sections 11.

A first exemplary embodiment of the interlocking connection 13 according to the invention between the spray nozzle sections 11 with one another and simultaneously with the spray nozzle tube 8 is apparent from viewing FIGS. 3 and 4 in combination. As these figures show, each spray nozzle section 11 has two latching sections 15 and two retaining sections 16 on its end facing away from the nozzle head 12. If the two spray nozzle sections 11 shown in FIG. 4 are now moved toward one another and thus toward the spray nozzle tube 8, the latching sections 15 of the first spray nozzle section 11 latch into the retaining sections 16 of the second spray nozzle section 11 and the latching sections 15 of the second spray nozzle section 11 latch into the retaining sections 16 of the first spray nozzle section 11. The two spray nozzle sections 11 are therefore interlockingly coupled to one another by means of the latching sections 15 and the retaining sections 16 and eventually encompass the spray nozzle tube 8. Due to the interlocking connection 13, the spray nozzle sections 11 are pressed against the spray nozzle tube 8 such that the interlocking connection 13 also brings about the connection of the spray nozzle sections 11 with the spray nozzle tube 8. The interlocking connection 13 therefore connects the spray nozzle sections 11 to form a unit 14 and simultaneously connects the spray nozzle 9, as a whole, to the spray nozzle tube 8.

In order to release the spray nozzle 9 from the spray nozzle tube 8, it is merely necessary to release the interlocking connection 13. Actuating sections 18 are preferably provided for this purpose, which can be acted upon with a force from the finger. This subsequently causes the latching sections 15 to move away from the retaining sections 16, such that the two sections 15, 16 become disengaged. Thereafter, the two spray nozzle sections 11 can be moved apart from one another and removed from the spray nozzle tube 8.

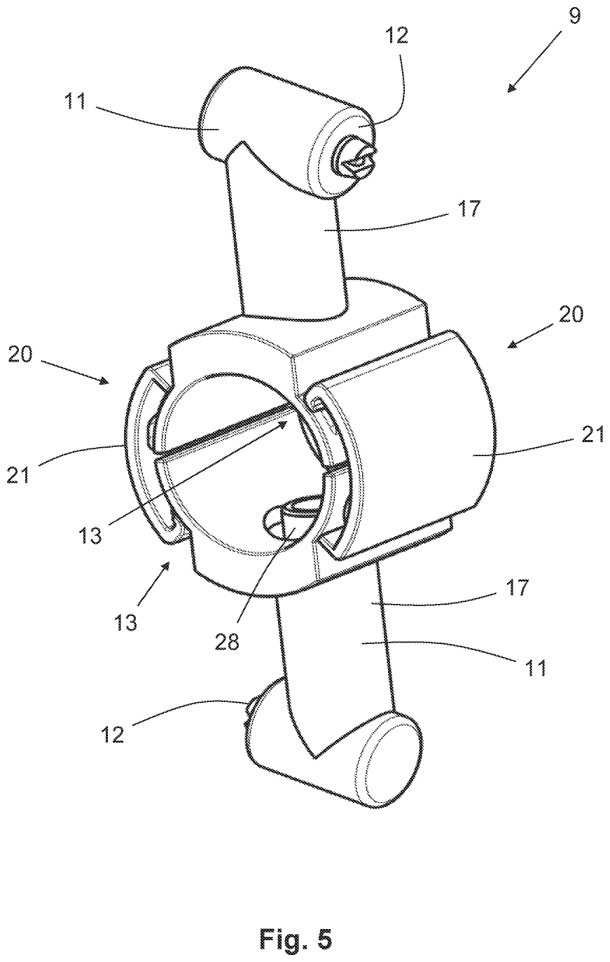

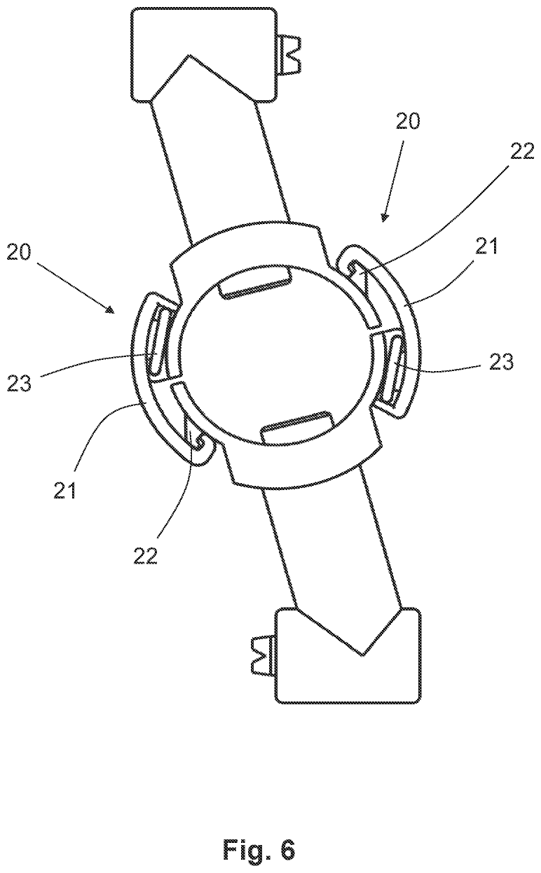

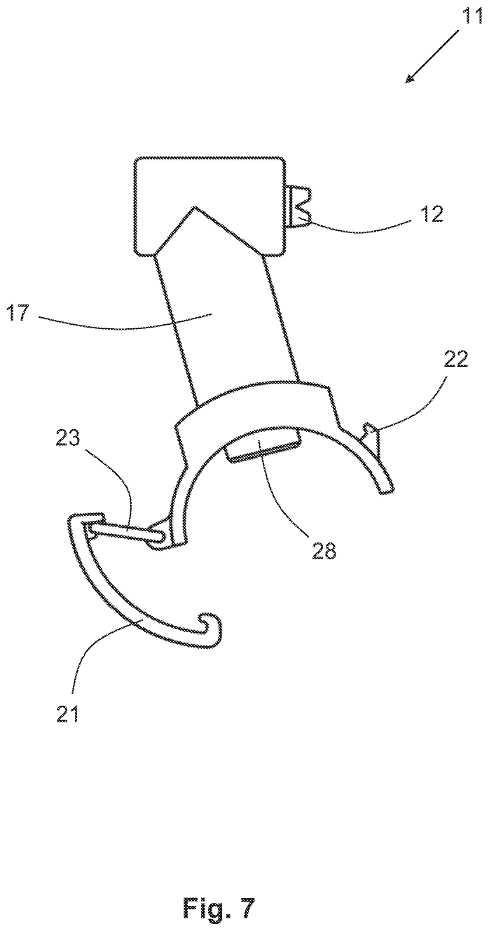

One further exemplary embodiment of an interlocking connection 13 is shown by FIG. 5 (perspective view of a spray nozzle 9 without a spray nozzle tube 8), FIG. 6 (side view of the spray nozzle 9 shown in FIG. 5) and FIG. 7 (a side view of a spray nozzle section 11 with the nozzle head 12 of the spray nozzle 9 shown in FIGS. 5 and 6).

Instead of the interlocking connection 13 shown in the preceding figures, each of which included latching sections 15 and retaining sections 16, the interlocking connection 13 in the second exemplary embodiment is formed by a toggle clamp 20. The toggle clamp 20, of which two are present, includes in the example shown a clamping arm 21 and a projection 22, each of which is an integral part of different spray nozzle sections 11. A clamping arm 21 of one spray nozzle section 11 therefore interacts with the projection 22 of the other spray nozzle section 11, and vice versa.

As the figures also show, a spring mechanism 23 (for example, in the form of an annular spring) is present, which holds the toggle clamp 20 under tension in its mounted state shown in FIGS. 5 and 6. As a result thereof, the toggle clamp 20 can be released only by overcoming the retaining force of the spring mechanism 23. In addition, both spray nozzle sections 11 are pressed against the spray nozzle tube 8 (not shown), which ensures the necessary tightness between the spray nozzle tube 8 and the spray nozzle 9 (the spray nozzle tube 8, which is not shown, also extends through the circular opening in the center of the spray nozzle 9 in this case, of course, similarly to the first exemplary embodiment).

The above-described exemplary embodiments describe an approach in which the two spray nozzle sections 11 are each designed as a spray nozzle arm, each of which has a nozzle head 12.

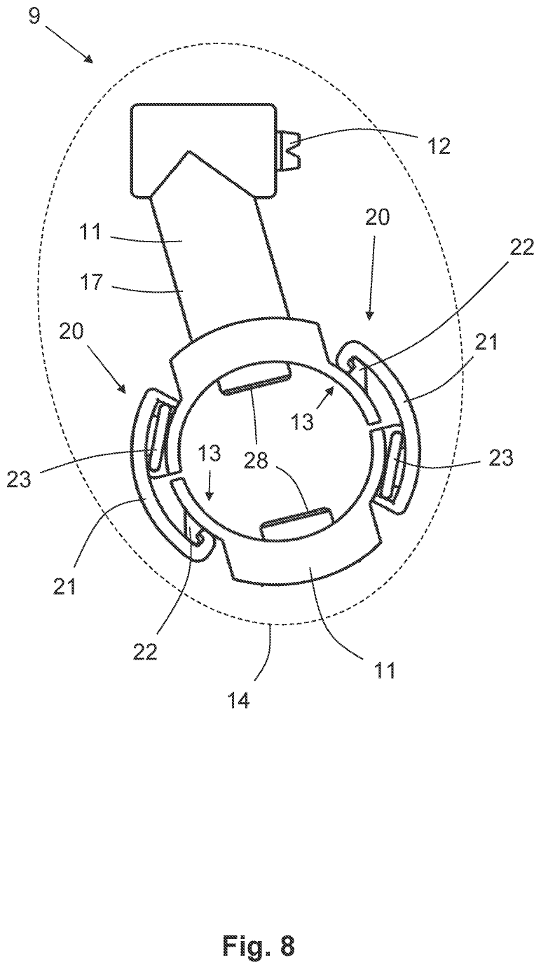

Alternatively, it is also possible that only one of the multiple spray nozzle sections 11 is designed as a spray nozzle arm. Such an approach is shown in FIG. 8. As is clear from this figure, the second spray nozzle section 11 does not have an arm section 17. Rather, the second spray nozzle section 11 acts merely as a counterpart to the first spray nozzle section 11 which includes the sole nozzle head 12 of the spray nozzle 9 shown. Both spray nozzle sections 11 can have the aforementioned connector 28 if corresponding openings 26 are present in the spray nozzle tube 8. If the spray nozzle tube 8 has only one opening 26 for the first spray nozzle section 11, however, the connector 28 of the second spray nozzle section 11 can be dispensed with. If the connector 28 of the second spray nozzle section 11 is present, it is to be designed to be liquid-tight, of course, in order to prevent an undesirable leak of cleaning liquid 10 in the area of the connector 28.

The embodiment according to FIG. 8 can also be transferred correspondingly to the exemplary embodiments shown in FIGS. 2 through 4, of course, which have a snap-in locking configuration rather than a toggle clamp 20. It is therefore also conceivable here that only one of the two spray nozzle sections 11 has an arm section 17 with a nozzle head 12.

The present invention is not limited to the exemplary embodiments shown and described. Modifications within the scope of the claims are also possible, as is any combination of the described features, even if they are represented and described in different parts of the description or the claims or in different exemplary embodiments, provided no contradiction to the teaching of the independent claims results.

### LIST OF REFERENCE CHARACTERS

1 rotational axis
2 drum
3 filter disk
4 filter surface
hollow space
6 spray nozzle arrangement
7 outer side
8 spray nozzle tube
9 spray nozzle
10 cleaning liquid
11 spray nozzle section
12 nozzle head
13 interlocking connection
14 unit
15 latching section
16 retaining section
17 arm section
18 actuating section
19 sealing element
20 toggle clamp
21 clamping arm
22 projection
23 spring mechanism
24 drive device
25 clip mechanism
26 opening
27 waste water opening
28 connector
29 central supply line

1-15. (canceled)

16. A rotary disk filter for filtering waste water, the rotary disk filter comprising:
a drum mounted so as to be rotatable about a rotational axis;
a plurality of filter disks, which are arranged next to one another and around the drum, the plurality of filter disks are mounted on the drum and are configured to be set into a rotary motion together with the drum via a drive device of the rotary disk filter, each filter disk of the plurality of filter disks having an inner hollow space, at least a portion of which is delimited by filter surfaces, wherein the hollow spaces of the plurality of filter disks are fluidically connected to the drum such that the waste water to be filtered can flow from an interior of the drum into the hollow spaces and, from there, the filtrate can flow across the filter surfaces toward an exterior of the filter disks; and
a spray nozzle arrangement configured to clean an outer side of the filter surfaces facing away from the hollow space, the spray nozzle arrangement including spray nozzle tubes which at least intermittently extend between each pair of adjacent filter disks of the plurality of filter disks during operation of the spray nozzle arrangement, each spray nozzle tube including multiple spray nozzles configured to spray a cleaning liquid onto the outer side of a filter surface facing the spray nozzle,
wherein:
the spray nozzles each have at least two spray nozzle sections;
at least one part of the at least two spray nozzle sections has a nozzle head;
the spray nozzles have an interlocking connection by which the at least two spray nozzle sections are connected to the spray nozzle tubes;
the spray nozzles can be removed from the spray nozzle tube once the interlocking connection has been released; and
during operation of the spray nozzle arrangement, the cleaning liquid flows from the spray nozzle tube through at least one part of the at least two spray nozzle sections connected to the spray nozzle tube to the nozzle heads and, from there, onto the outer side of one of the filter surfaces.

17. The rotary disk filter of claim 16, wherein the at least two two spray nozzle sections in each case are combined via the interlocking connection to form a unit, wherein the at least two spray nozzle sections are designed, in particular, as spray nozzle arms, each of which has a nozzle head, the spray nozzle arms projecting from the spray nozzle tube in opposite directions with respect to the spray nozzle tube supporting the at least two spray nozzle sections.

18. The rotary disk filter of claim 17, wherein the at least two spray nozzle sections of one unit are directly connected to one another via the interlocking connection.

19. The rotary disk filter of claim 16, wherein the interlocking connection is formed by a latching mechanism, wherein the latching mechanism includes a latching section which is a component of a first spray nozzle section of the at least two spray nozzle sections of a unit, the latching mechanism including a retaining section which is a component of a second spray nozzle section of the at least two spray nozzle sections of the unit, wherein the latching section and the retaining section interact and jointly form the interlocking connection, and wherein the first and second spray nozzle sections of the unit are pressed against the spray nozzle tube supporting the unit via the latching mechanism.

20. The rotary disk filter of claim 19, wherein each of the first and second spray nozzle sections has at least one latching section and at least one retaining section, wherein the at least one latching section of the first spray nozzle section interacts with the at least one retaining section of the second spray nozzle section, and wherein the at least one latching section of the second spray nozzle section interacts with the at least one retaining section of the first spray nozzle section.

21. The rotary disk filter of claim 20, wherein the latching sections of the unit arranged on opposite sides of the spray nozzle tube supporting the unit and/or the retaining sections the unit are arranged on opposite sides of the spray nozzle tube supporting the unit.

22. The rotary disk filter of claim 19, wherein the latching section has a actuating section which projects from the spray nozzle tube, wherein the actuating section is configured to allow the latching section to be manually moved apart from the retaining section in order to release the interlocking connection due to the movement.

23. The rotary disk filter of claim 16, wherein at least one spray nozzle section of each spray nozzle has an arm section which projects from the spray nozzle tube to which it is connected, wherein the corresponding spray nozzle section is formed in one piece and the arm section includes one or more latching sections and/or one or more retaining sections, and wherein the arm section is connected to one of the nozzle heads.

24. The rotary disk filter of claim 23, wherein the one or more latching sections and/or the one or more retaining sections of the arm section extend in a circumferential direction around a section of one of the spray nozzle tubes and/or that the one or more latching sections is formed by a latching hook.

25. The rotary disk filter of claim 16, wherein one nozzle head in each case is screwed together with each of the at least two spray nozzle sections and is connected thereto via a clip mechanism or is pressed together therewith.

26. The rotary disk filter of claim 16, wherein each spray nozzle has exclusively two spray nozzle sections, each of the two spray nozzle sections having a sealing element arranged between the particular spray nozzle section and the spray nozzle tube and having a sealing element arranged between the particular spray nozzle section and a nozzle head connected thereto.

27. The rotary disk filter of claim 16, wherein the interlocking connection is formed by a toggle clamp, wherein the toggle clamp at least one clamping arm and at least one projection, wherein the at least one clamping arm in each case is engaged with the at least one projection, and wherein the at least two spray nozzle sections are pressed against the spray nozzle tube due to the interaction of the at least one clamping arm with the at least one projection.

28. The rotary disk filter of claim 27, wherein the toggle clamp includes a spring mechanism that is configured to hold the toggle clamp under tension, wherein the toggle clamp is configured to be opened by overcoming the spring force of the spring mechanism.

29. The rotary disk filter of claim 16, wherein first and second spray nozzle sections of the at least two spray nozzle sections form a unit, wherein each of the first and second spray nozzle sections includes a clamping arm and a projection, wherein the clamping arm of the first spray nozzle section of the unit is operatively connected to the projection of the second spray nozzle section and the clamping arm of the second spray nozzle section of the unit is operatively connected to the projection of the first spray nozzle section of the unit.

30. The rotary disk filter of claim 29, wherein the clamping arms of the unit are arranged on opposite sides of the spray nozzle tube supporting the unit and/or the projections of the unit are arranged on opposite sides of the spray nozzle tube supporting the unit.

31. A spray nozzle for a rotary disk filter which is used to filter waste water, wherein the spray nozzle is configured as recited in claim 1.
